(19) United States
(12) Patent Application Publication
(10) Pub. No.: US 2023/0364937 A1
(43) Pub. Date: Nov. 16, 2023

(54) MARKING MACHINE

(71) Applicant: AUTOMATOR MARKING SYSTEMS S.R.L., MILANO (IT)

(72) Inventor: Jaime Alberto BARCILON BRAMBILLA, MILANO (IT)

(73) Assignee: AUTOMATOR MARKING SYSTEMS S.R.L., MILANO (IT)

(21) Appl. No.: 18/044,837

(22) PCT Filed: Sep. 10, 2021
(86) PCT No.: PCT/IB2021/058251

§ 371 Date: Mar. 10, 2023

(30) Foreign Application Priority Data
Sep. 11, 2020 (IT) 102020000021568

(51) Int. Cl. B44B 3/06

(52) U.S. Cl. CPC B44B 3/061; B44B 3/009

(57) ABSTRACT

A marking machine having a marking head provided with a percussion tool configured to alter at least partly a surface of an object to be marked, a movement device/component/unit/apparatus or the like configured to move said percussion tool along a direction of percussion, and a heating assembly configured to heat said percussion tool.

### TECHNICAL FIELD

The present invention relates to a marking machine, in particular to a microdot marking machine or also called a micro-pressure marking machine.

### BACKGROUND ART

Various marking technologies are known through which it is possible to alter the surface of an object to be marked in order to imprint desired shapes or lettering thereon.

Among the different technologies, the microdot marking is known to involve the realization, on the surface of the object to be marked, of a series of grooves or cavities arranged one next to the other so that, as a whole, they represent the desired shape or writing.

In detail, microdot marking machines are usually provided with a marking head arranged superiorly to a supporting surface of the object to be marked. The marking head comprises a percussion tool movable, e.g. pneumatically, perpendicularly to the supporting surface to engrave the surface of the object to be marked.

The marking head is movable along two linear guides at right angles to each other and parallel to the supporting surface so that by moving the marking head it is possible to make a series of grooves on the surface of the object to be marked in order to trace the desired shape.

The microdot marking machine allows marking surfaces even of considerable hardness. However, it is ineffective when used to work on materials of the elastic type such as hide, leather, plastic, etc. In fact, as these materials undergo elastic deformation, the grooves made by the percussion tool tend to vanish or are not visible as well as the marked shape.

In the prior art, the materials of the elastic type are usually worked by means of a hot marking technology wherein a punch is used provided with a die embossed with the desired shape. The punch is heated and pressed in abutment against the surface to be marked to engrave the shape represented by the die. By using heat it is possible to change the physical state of the portion of the surface pressed by the punch and mark the object permanently.

However, hot marking by means of a punch is impractical and extremely expensive when used to mark one or more objects with various types of shape or lettering. In this case, this technology would require the use of several interchangeable dies, each corresponding to a specific shape to be marked. If, for example, in a production line of products it is necessary to mark each product with different shapes or lettering, hot marking by means of a punch requires the use of a different die for each marking. In addition, the operations to replace the die on the punch would require extremely long production times. Finally, it should be noted that the appliances provided with a punch are not adapted to receive external inputs to make special markings according to predefined drawings.

### DESCRIPTION OF THE INVENTION

The Applicant has thus devised to make permanent engravings in elastic materials having any shape and made with a single tool in order to be able to draw any shape in a practical and inexpensive way, without necessarily having to replace the tool according to the shape to be engraved.

The Applicant has thus discovered that, by using a suitable heating assembly, it is possible to convey heat to the percussion tool without affecting the overall operation of the machine, thus preserving the state of the machine components and keeping the user safe.

Therefore, the present invention relates to a marking machine according to claim 1 having structural and functional characteristics such as to meet the above requirements while at the same time overcoming the drawbacks mentioned above with reference to the prior art.

### BRIEF DESCRIPTION OF THE DRAWINGS

Other characteristics and advantages of the present invention will become more apparent from the description of a preferred, but not exclusive, embodiment of a marking machine, illustrated by way of an indicative, yet non-limiting example, in the accompanying tables of drawings wherein:

FIG. 1 is a front view of the marking machine according to the present invention,

FIG. 2 is a perspective and detailed view of the machine in FIG. 1,

FIG. 3 is a sectional view of the cylindrical body of the machine in FIG. 1,

FIGS. 4 and 5 are perspective views of the cylindrical body in different embodiments.

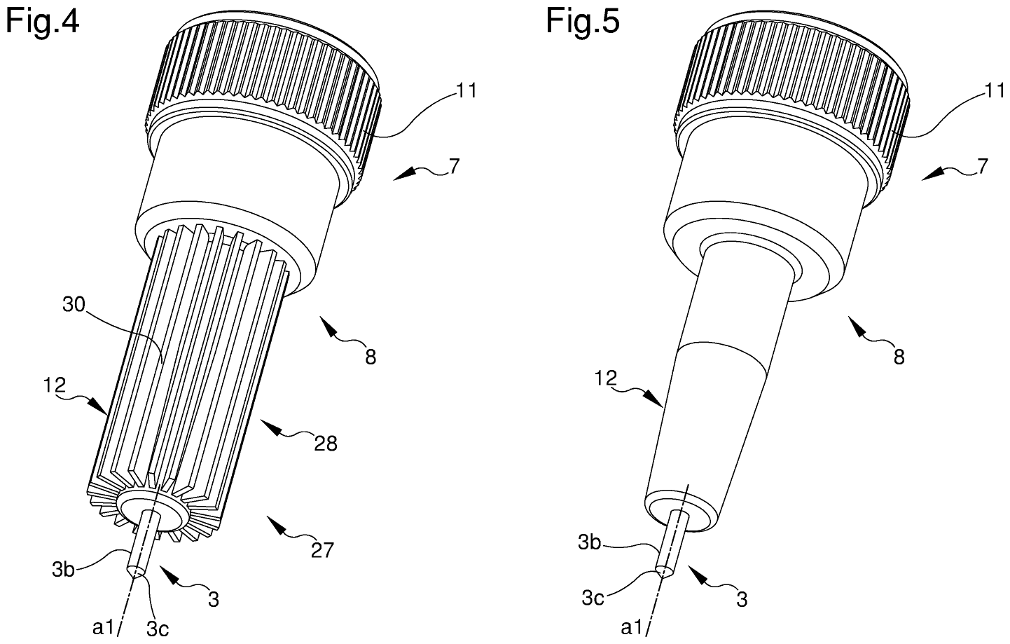

### EMBODIMENTS OF THE INVENTION

With particular reference to such figures, reference numeral 1 globally indicates a marking machine, in particular a microdot marking machine.

The term “microdots” relates to one or more grooves or cavities made on a surface of an object to be marked, generally having a substantially circular shape and a diameter of between 1 mm and 20 mm. The term “microdots” may similarly be understood to mean a single groove made by sliding as explained in detail later in this description.

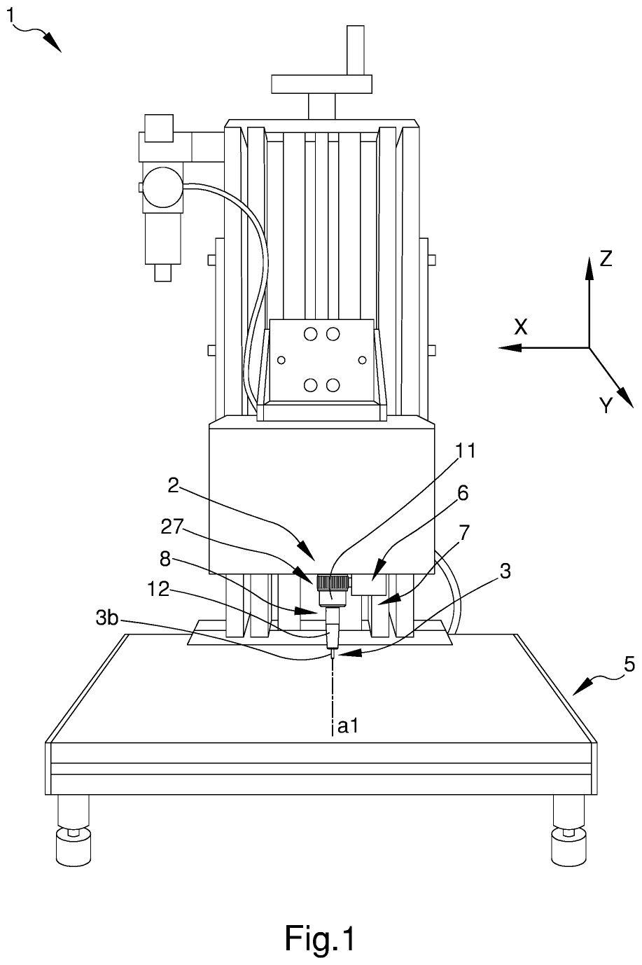

The marking machine 1 according to the present invention enables marking the surface of an object by making a series of microdots arranged close to each other or made by sliding which together define a predefined shape or lettering. As shown in FIG. 1, the machine 1 comprises a marking head 2 provided with a percussion tool 3 configured to alter at least partly a surface of an object to be marked in order to make one or more microdots. In particular, the percussion tool 3 is constrained in a sliding manner to the marking head 2 along at least one direction of percussion al. Preferably, the direction of percussion al is, in use, substantially vertical and parallel to the axis Z-Z of a Cartesian reference system. For this purpose, the marking head 2 comprises movement means 4 configured to move the percussion tool 3 along the direction of percussion al.

In the context of the present disclosure, the terms “upper”, “lower”, “vertical” and “horizontal”, when used with reference to the machine 1, are intended to refer to conditions of normal use of the machine 1, i.e. those shown in FIG. 1.

In one or more versions, the machine 1 may comprise a supporting surface 5 of the object to be marked positioned inferiorly to the marking head 2 so that, in use, the object to be marked may be arranged along the direction of percussion al. The movement means 4 may thus move the percussion tool 3 away from/close to the surface to be marked to make one or more microdots.

It cannot however be ruled out that the machine 1 is without the supporting surface 5 and may be of a portable type (so-called “hand-held device”) so that the marking head 2 can be placed at will on the object to be marked.

In one or more versions, the machine 1 may comprise a frame, not shown in the figures, adapted to peripherally define a marking area inside which the surface of the object to be marked is intended to be arranged.

Advantageously, the machine 1 comprises a heating assembly 6 configured to heat the percussion tool 3. In particular, the heating assembly 6 is configured to heat the percussion tool 3 at an operating temperature comprised between 60° and 600° C., preferably between 100° C. and 400° C., even more preferably 350° C. Such a temperature allows the percussion tool 3 to transfer to the impacted surface an amount of heat which substantially changes the physical state thereof. After the contact is terminated, the impacted surface, as it cools down, returns to its initial physical state, by substantially maintaining permanently the surface alterations made by the heat applied by the percussion tool 3.

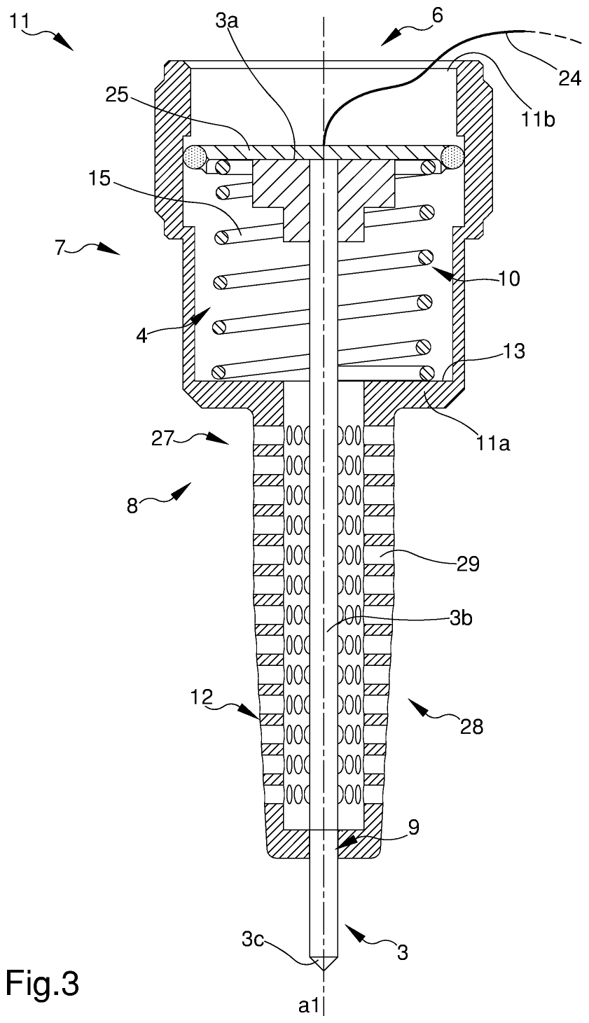

In one or more versions, and as shown in FIG. 3, the percussion tool 3 has a nail-like shape in which a head 3a is identified as well as a stem 3b of elongated shape along a prevailing direction of development and a percussion tip 3c positioned at the lower free end of the stem 3b and intended to operate on the marking surface.

Preferably, the percussion tip 3c may have different shapes, e.g., pointed, blunt, rounded, truncated, square or rectangular, with a predefined logo/die, ball-shaped, etc. Furthermore, the end portion of the stem 3b may be made with one or more branches (e.g., in the form of an inverted fork) ending with respective percussion tips 3c.

Preferably, the head 3a has a diameter larger than the diameter of the stem 3b.

Advantageously, the percussion tool 3 is made at least partly of a metal thermal conductive material, such as e.g. steel, brass, etc. In this way, the percussion tool 3 may have a high melting temperature, at least above 800° C., so as to be able to rapidly heat the surface of the object to be marked, thus resulting in high performance in making microdots on objects made of elastic material.

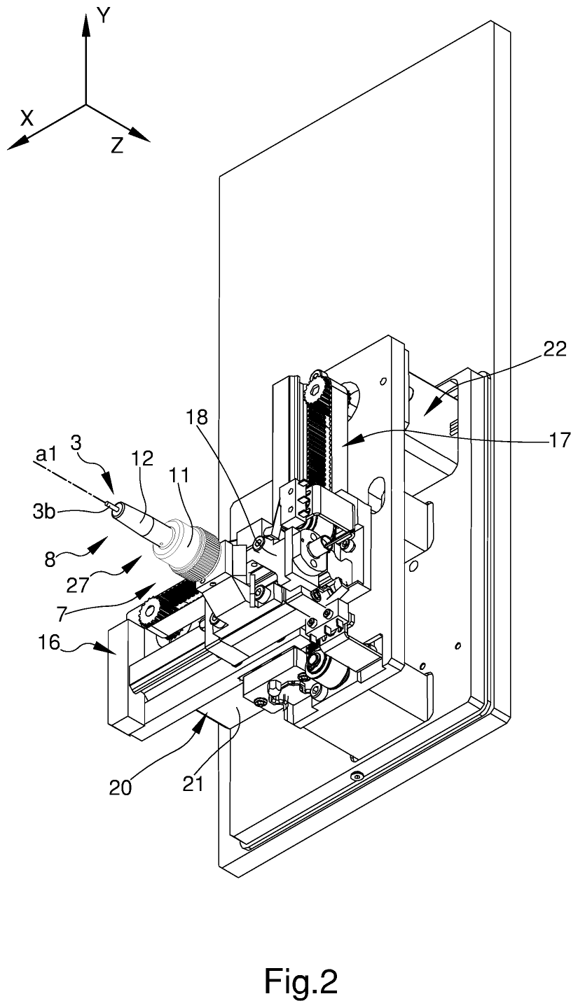

As shown in FIG. 2, the machine 1 comprises constraining means 7 configured to constrain the percussion tool 3 to the marking head 2. In detail, the constraining means 7 comprise a cylindrical body 8 adapted to house at least partly the percussion tool 3, and a through hole 9 for the transit and sliding of at least one portion of the percussion tool 3. Preferably, the cylindrical body 8 is configured to be associated with the marking head 2 by means of, e.g., a coupling of a threaded, snap-on, clipped, etc. shape.

In one or more embodiments, the cylindrical body 8 defines therein a housing compartment 10 wherein an upper portion 11 and a lower portion 12 are identified and configured to house the head 3a and the stem 3b respectively, of the percussion tool 3. Preferably, the lower portion 12 is tapered downwards.

In detail, the upper portion 11 of the cylindrical body 8 has an internal diameter substantially coincident with the diameter of the head 3a of the percussion tool 3 and, at the same time, greater than the diameter of the lower portion 12. Preferably, the latter has a diameter substantially coincident with the diameter of the stem 3b of the percussion tool 3. Such a conformation allows the cylindrical body 8 to constrain the percussion tool 3 in a sliding manner by blocking the head 3a in abutment by means of an abutment portion 13 obtained internally to the upper portion 11.

The upper portion 11 of the cylindrical body 8 extends between a lower end 11a and an upper end 11b. The movement means 4 allow alternately moving the head 3a of the percussion tool 3 inside the cylindrical body 8 between the two ends 11a, 11b along the direction al from and towards the surface to be marked so that the stem 3b, and thus the percussion tip 3c, intermittently operates on the surface to be marked.

It should be specified that the movement of the percussion tool 3 may be carried out according to a plurality of techniques. For example, the movement means 4 may be of a combined type to guide the close movement (forward) of the tool 3 to the air marking surface by means, e.g., of suitable compressor means, while the away movement (return) is carried out by means of a spring. Otherwise, it is possible to guide the movement of the tool 3 both forward and return by air or, in a further version, by using electric solenoid assemblies both forward and return.

The movement means 4 may therefore comprise a compressor, not shown in the figures, configured to emit an aeriform fluid, preferably compressed air, internally to the cylindrical body 8. For this purpose, the compressor is connected in a fluid-operated manner to the cylindrical body 8, preferably at the upper end 11b.

The movement means 4 may also comprise at least one elastic element 15, preferably a spring, arranged internally to the upper portion 11 of the cylindrical body 8 and positioned between the lower end 11a and the head 3a of the percussion tool 3.

Conveniently, the compressor and the spring 15 operate in conjunction to move the percussion tool 3 along the direction of percussion al away from/close to the surface of the object to be marked. In detail, the compressor, by emitting compressed air inside the cylindrical body 8, exerts a force on the head 3a of the percussion tool 3 able to move the latter close to the object to be marked in order to partly pierce it and compress the spring 15 at the same time. The latter subsequently operates in the opposite direction to the direction of air delivery to exert an elastic return force on the head 3a of the percussion tool 3 to move it away from the object to be marked so that the tip 3c moves away from the marking surface of the object to be marked.

In one or more versions not shown in the figures, the movement means 4 may comprise an electromagnetic actuator, preferably a solenoid actuator, provided with a coil connected to an electric circuit for the sliding of the percussion tool 3 according to electric movement techniques known in themselves.

As shown in FIG. 2, the marking head 2 is movable along at least one first 16 and one second linear guide 17 which are orthogonal to each other and arranged substantially perpendicular to the direction of percussion al. In actual facts, the linear guides 16, 17 are arranged parallel to the axes X-X, Y-Y respectively, of a Cartesian reference system. The marking head 2 slides along the linear guides 16, 17 to move the percussion tool 3 along a predefined trajectory in order to trace the desired shape on the object to be marked. In detail, the displacement of the marking head 2 combined with the movement of the percussion tool 3 allows the machine 1 to make a series of microdots which, as a whole, define the shape to be marked on the object. By varying the movement of the marking head 2, it is possible to trace different shapes or lettering on the object to be marked.

In a further embodiment, the movement means 4 are configured to hold the percussion tip 3c of the percussion tool 3 against the marking surface during the movement of the marking head 2 along the axes X-Y so as to make one or more continuous grooves.

In one or more embodiments, the marking head 2 is mounted on a first carriage 18 configured to slide along the first linear guide 16. The first linear guide 16 is in turn mounted on a second carriage 19 configured to slide along the second linear guide 17.

Preferably, the carriages 18, 19 are connected to the respective linear guides 16, 17 by means of a guide system, preferably with ball screw.

Conveniently, the machine 1 comprises actuator means 20 configured to move the carriages along respective linear guides 16, 17. In detail, the actuator means 20 comprise a first motor 21 and a second motor 22 to move the first carriage 18 and the second carriage 19, respectively. Preferably, the motors 21, 22 are of the precision electric type, such as a stepper motor, and transmit motion to the respective carriages 18, 19 by means of a belt mechanism.

Conveniently, the machine 1 comprises processing means, not shown in the figures, in signal communication, e.g. by means of an electric circuit, with the movement means 4 and with the actuator means 20 to control the operation thereof. In particular, the processing means are configured to generate a signal representative of the movement instructions of the marking head 2 and of the percussion tool 3.

In detail, the processing means are configured to receive at input, e.g. by means of proprietary word processing software, a signal representative of the shape or lettering to be imprinted on the surface of the object to be marked. The processing means send to the actuator means 20 and to the movement means 4 a signal representative of the movement instructions of the marking head 2 and of the percussion tool 3. Finally, the latter operate in conjunction synergistically with each other to trace the desired shape or lettering on the surface of the object to be marked. In detail, the actuator means 20 move the marking head 2 along the linear guides 16, 17 to arrange the percussion tool 3 at one or more predefined positions. After being positioned, the percussion tool 3 is moved by the movement means 4 along the direction of percussion al in order to make the microdots.

In one or more versions, heat generation is preferably achieved by means of an electric circuit 24 associated with an electric heating element 25 to receive a predetermined amount of current.

In actual facts, the heating assembly 6 comprises a current generator operatively connected to the electric heating element 25 by means of the electric circuit 24. Advantageously, the electric heating element 25 is associated with the percussion tool 3 to transfer heat to the head 3a which transfers, by induction, heat to the stem 3b and then to the tip 3c.

Preferably, induction is carried out by means of an external or internal coil.

Conveniently, an electronic controller, not shown in the figures, can be provided to control the amount of electric current circulating in the electric heating element 25 according to the amount of heat to be transferred to the head 3a of the percussion tool 3.

In one or more versions, the electric heating element 25 is directly in contact with the head 3a of the percussion tool 3. Alternatively, the percussion tool 3 itself operates as a resistor. Substantially, the electric heating element 25 is at least partly the percussion tool 3. For this purpose, the percussion tool 3 comprises an inner layer made of an electrically conductive material to operate as the electric heating element 25, and an outer layer made of an electrically insulating material. In this way, the percussion tool 3 can transmit the heat generated by the electric heating element 25 to the tip 3c only, avoiding heat transfer to the user and/or the machine 1 while maintaining a very high overall safety during use. In detail, the inner layer extends between the head 3a and the tip 3b and, preferably, it is operatively connected to the electric circuit 24 at the head 3a.

In a further version, the percussion tool 3 can be made of several components. For example, it is possible to provide an upper part made of an insulating material connected to a lower conductive end part, the latter being adapted to transfer heat to the percussion tip 3c. Preferably, the tool 3 may be associated with the heating assembly 6, which in one version may comprise an electric coil wound around the lower conductive end portion to transfer heat therefrom.

Advantageously, the machine 1 comprises thermal insulation means 27 configured to thermally insulate at least partly the percussion tool 3, thus preventing the heat generated by the heating assembly 6 from damaging the components of the machine 1 and being harmful to the user.

In one or more versions, the cylindrical body 8 is made at least partly of a thermal insulating material so as to itself operate as a thermal insulation means 27.

Conveniently, the heating assembly 6 is mounted on the cylindrical body 8 or inside the marking head 2. This solution allows the heating assembly 6 to be moved together with at least the marking head 2, thereby preventing the various components required to generate heat and transfer it to the percussion tool 3 from being damaged during the movement of the marking head 2, for example by being twisted or torn.

Advantageously, the cylindrical body 8 may comprise heat dissipation means 28 configured to dissipate heat generated and transmitted by the percussion tool 3.

In one or more versions, the heat dissipation means 28 comprise one or more openings 29 made along the cylindrical body 8, preferably along the lower portion 12 of the cylindrical body 8.

Alternatively or in combination with the presence of the openings 29, the heat dissipation means 28 may comprise one or more dispersion fins 30 arranged on the outer surface of the cylindrical body 8.

In one or more versions, the machine 1 may comprise a coloring tape, not shown in the figures, having at least one color layer and configured to release the color layer when subjected to a specific amount of heat.

In detail, the coloring tape may be arranged along the direction of percussion al between the surface of the object to be marked and the percussion tool 3. In this way, when the percussion tool 3 is moved along the direction of percussion al, the latter presses the coloring tape against the surface of the object to be marked by heating it. Thus, the coloring tape releases the color layer at the contact point by coloring the surface of the object to be marked.

In one or more versions, the machine 1 comprises a tape unwinder configured to place a portion of color tape between the percussion tool 3 and the object to be marked.

It has in practice been ascertained that the described invention achieves the intended objects, and in particular the fact is emphasized that by means of the marking machine it is possible to permanently mark objects of the elastic and/or organic type, being able to vary the shape to be marked in a practical and fast manner. It is possible to create any type of logo, image, alpha-numeric lettering, codes (data matrix, QR code, bar code, etc.) with a single percussion tool while keeping the machine and the users safe.

1. A marking machine comprising:
a marking head provided with a percussion tool configured to alter at least partly a surface of an object to be marked,
movement means configured to move said percussion tool along a direction of percussion, and
a heating assembly configured to heat said percussion tool.

2. The machine according to claim 1, wherein
said heating assembly is configured to heat said percussion tool at an operating temperature comprised between 60° and 600° C.

3. The machine according to claim 1, wherein
said heating assembly comprises at least one electric heating element associated with said percussion tool and an electric circuit configured to let a predetermined amount of current flow in said electric heating element.

4. The machine according to claim 3, wherein
said electric heating element is said percussion tool.

5. The machine according to claim 1, wherein
said percussion tool made at least partly of a metal thermal conductive material.

6. The machine according to claim 1, further comprising:
thermal insulation means configured to thermally insulate at least partly said percussion tool.

7. The machine according to claim 1, wherein
said marking head comprises a cylindrical body configured to house at least partly said percussion too, said cylindrical body being made at least partly of a thermal insulating material.

8. The machine according to claim 7, wherein
said heating assembly is mounted on said cylindrical body or inside said marking head.

9. The machine according to claim 7, wherein
said cylindrical body comprises heat dissipation means.

10. The machine according to claim 1, wherein
said marking head is movable along at least one first and one second linear guide substantially orthogonal to each other and substantially perpendicular to said direction of percussion.

11. A marking machine comprising:
a marking head provided with a percussion tool configured to alter at least partly a surface of an object to be marked,
a tangible movement device or apparatus configured to move said percussion tool along a direction of percussion, and
a heating assembly configured to heat said percussion tool.

12. The machine according to claim 11, further comprising:
a tangible thermal insulation device or apparatus configured to thermally insulate at least partly said percussion tool.

13. The machine according to claim 11, wherein
said marking head comprises a cylindrical body configured to house at least partly said percussion tool, said cylindrical body being made at least partly of a thermal insulating material.

14. The machine according to claim 13, wherein
said cylindrical body comprises a heat dissipator.
